(19) United States
(12) Patent Application Publication
(10) Pub. No.: US 2011/0256052 A1
(43) Pub. Date: Oct. 20, 2011

(54) SYSTEM AND METHOD FOR THE GENERATION OF HYDROGEN FUEL PRODUCT

(76) Inventor: THOMAS MERRITT, HOLLYWOOD, FL (US)

(21) Appl. No.: 13/087,727

(22) Filed: Apr. 15, 2011

Related U.S. Application Data
(60) Provisional application No. 61/324,603, filed on Apr. 15, 2010.

(51) Int. Cl. C01B 3/10; B01J 19/00; F22B 1/18; C01B 3/04; F02B 65/00; F01D 1/00

(52) U.S. Cl. 423/658; 123/3; 60/670; 122/7 R; 423/658.2; 423/657; 422/643

(57) ABSTRACT

A system and method for producing a hydrogen fuel gas is provided. In particular, a hydrogen fuel product is produced from steam exposed to a heated catalyst, wherein at least a portion of the hydrogen fuel product produced is used in the system.

### CROSS-REFERENCE TO RELATED APPLICATIONS

The present application claims priority to co-pending Provisional Patent Application No. 61/324,603, filed on Apr. 15, 2010, entitled SYSTEM AND METHOD FOR THE GENERATION OF HYDROGEN FUEL PRODUCT, that application being incorporated herein, by reference, in their entirety.

### BACKGROUND OF THE INVENTION

1. Field of the Invention

The present application relates to the production of a hydrogen fuel product, and more particularly, to a system and method for producing a hydrogen fuel product from water, which fuel product may be recycled into the system.

2. Description of the Related Art

A hydrogen economy has been proposed for the distribution of energy using hydrogen. Hydrogen (H₂) releases energy when it is combined with oxygen; however in the past, production of hydrogen from water requires more energy than is released when the hydrogen is used as fuel. As such, past methods of producing hydrogen have been prohibitively expensive as compared to other fuels for the same amount of energy return.

What is needed is a system for producing hydrogen that is relatively inexpensive. What is further needed is a method for producing energy (i.e., electricity, mechanical motion, etc.,) wherein hydrogen is provided as a waste product.

### SUMMARY OF THE INVENTION

A system and method for generating a hydrogen fuel product is provided. Water, in the form of steam, is super-heated and exposed to a catalyst to produce a hydrogen gas, which is stored and/or recycled as fuel back into the system.

In one particular embodiment of the invention, hydrogen produced in the system is used to produce a fuel mixture that, when ignited, heats water to make steam that can drive a turbine and/or be used with a catalyst to create further hydrogen gas fuel product.

Other features which are considered as characteristic for the invention are set forth in the appended claims.

Although the invention is illustrated and described herein as embodied in a system and method for the generation of a hydrogen fuel product, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWINGS

For a fuller understanding of the nature of the present invention, reference should be made to the following detailed description, taken in connection with the accompanying drawings in which:

FIG. 1 is a schematic diagram of a fuel gas production system in accordance with one particular embodiment of the present invention.

FIG. 2 is a schematic diagram of a fuel gas production system in accordance with another particular embodiment of the present invention.

FIG. 3 is a schematic diagram of a fuel gas production system in accordance with a further particular embodiment of the present invention.

FIG. 4A is a schematic diagram of one particular embodiment of a catalytic converter section having a bypass switch closed to create two different streams out from the catalytic converter section.

FIG. 4B is a schematic diagram of the catalytic converter section of FIG. 4A wherein the bypass switch is opened to provide a single stream out from the catalytic converter section.

Like reference numerals refer to like parts throughout the several views of the drawings.

### DESCRIPTION OF THE INVENTION

The system of the instant invention converts water (H₂O) vapor to a hydrogen fuel gas using a catalyst subjected to high temperatures. This hydrogen fuel gas can be stored and used, for example, in connection with an internal combustion engine. As will be described, in one particular embodiment of the invention, hydrogen fuel gas produced from water vapor is used as a combustion product in an internal combustion engine.

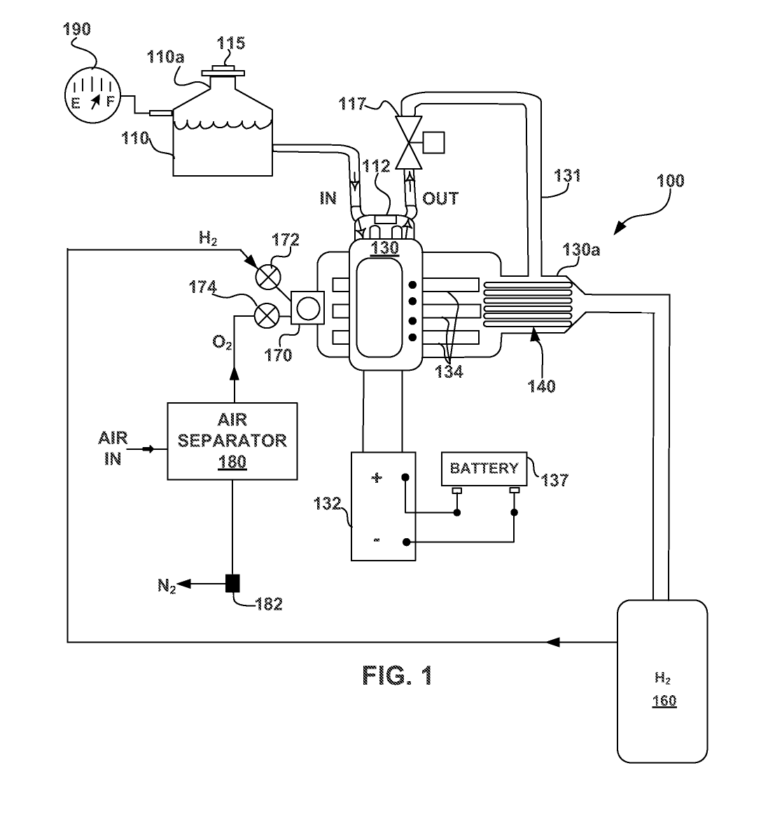

Referring now to FIG. 1, there is shown a system 100 for producing a hydrogen fuel gas, in accordance with one particular embodiment of the instant invention. The system 100 will be described in connection with an internal combustion engine and, if desired, can be implemented in a vehicle, such as a car, truck, bus, boat, tractor, farm implement and/or any other vehicle in which an internal combustion engine is currently used. Alternately, the system 100 can be implemented for generating electricity, such as in a household and/or industrial generator. However, as shown in FIG. 1, the system 100 is built around the internal combustion engine 130, which, in the present embodiment, is a hydrogen-burning internal combustion engine. In one particular embodiment, the internal combustion engine 130 is a hydrogen-burning internal combustion engine made from ceramic or ceramic containing materials.

Internal combustion engines that generate power from the combustion of hydrogen are known. As with a traditional motor vehicle internal combustion engine, the engine 130 is cooled by a liquid which, in the present case, is water from a tank 110. Additionally, as with conventional motor vehicles, the operation of the internal combustion engine 130 powers an alternator 132 that provides at its output a DC current that can be used to power an electric motor and/or provide electrical power to other systems.

As further shown in FIG. 1, the system 100 includes the tank 110 in which water (H₂O) is supplied to the system from an external water source. The water in tank 110 is, preferably, distilled water, but can be other types of water, including common hose-fed tap water. The tank 110 has an access port 110a that is externally accessible for filling the tank 110 with water, much like present day gas tanks. The tank 110a access port 110a that can be closed by a cap 115.

In the instant embodiment, the water from the tank 110 is supplied to an inlet port IN of the internal combustion engine 130, via a pump 112, wherein it is used to cool the internal combustion engine 130 by being recirculated within the engine 130. The temperature of the water in the engine 130 is rapidly increased by its passage through the cylinders and heads of the engine 130, and the water is converted to a steam (i.e., water vapor). This steam leaves the engine 130 via an outlet port OUT and a pressure control valve 117, which provides the steam, via pipe 131 or exhaust manifold 134, to an outlet manifold or catalytic converter section 130a of the engine 130.

In one particular embodiment of the present invention, a catalyst or catalyzing agent 140 is provided in the catalytic converter section 130a of the engine 130. At high temperatures, the catalyzing agent 140 reacts with steam to produce hydrogen gas (H₂). In the embodiment of FIG. 1, steam is exposed to a heated catalyst 140 in the catalytic converter section 130a from one of two sources: 1) from the pressure control valve 117; and 2) from the combustion product of the internal combustion engine 130. Note that, at atmospheric pressure, the boiling temperature of water will not go above 212° F. As such, the operating pressure of the system can be adjusted using the pressure control valve 117 to change the boiling temperature of the water by raising it or lowering it, as desired. The catalyzing agent 140 will be heated as a result of the temperature rise of the exhaust from the exhaust manifold 134 created by the combustion of H₂ and O₂ in the combustion chamber of the engine 130.

In one particular embodiment of the invention, the active catalyst of the catalyzing agent 140 is iron (Fe). The method of generating hydrogen by passing steam over hot iron (Fe), also known as reforming steam, was previously performed inefficiently. However, in the present embodiment of the invention, this method becomes extremely efficient, with copious amounts of H₂ being created. Steam exposed to the heated catalyzing agent 140 contained in the catalytic converter section 130a of the internal combustion engine 130 produces hydrogen (H₂). When generating hydrogen, the catalyzing agent 140 can be chosen to be the element Fe, preferably in the form of iron sponge. The reaction, when heated, is described by H₂O+Fe=>Fe₃O₄+H₂. Additionally, magnesium and/or zinc can be used in place of, or in addition to, iron as the catalyzing agent 140, with the end product still being H₂. This is not meant to be limiting, however, as other materials that react with steam to oxidize, thus producing H₂ gas, can also be used.

Referring back to FIG. 1, the catalyzing agent 140 is located adjacent to the combustion chamber of the internal combustion engine 130 in the catalytic converter section 130a, and is superheated by the heat of combustion of the fuel mixture in the internal combustion engine 130. In particular, the combustion temperature of hydrogen is about 1500° F. Thus, locating the catalyzing agent 140 in close proximity to the combustion of hydrogen fuel in the system 100 by, in the instant embodiment, locating the catalyzing agent 140 near the exhaust pipes 134, will superheat the catalytic converter section 130a containing the catalyzing agent 140.

When the catalyzing agent 140 is heated by the waste heat from the hydrogen fuel combustion, the steam in the catalytic converter section 130a exposed to the catalyzing agent 140 will react with the active catalyst of the catalyzing agent 140 to produce hydrogen (H₂). The hydrogen thus produced can be routed to the tank 160, located at the output of the catalytic converter 140, for storage and/or use.

If desired, at least a portion of the hydrogen gas that is produced could be diverted from the storage tank 160 for use outside of the system 100. The remainder of the hydrogen produced from the steam exposed to the superheated catalyzing agent 140 is used as fuel in the system 100. Additionally, the instant invention generates electricity, while creating hydrogen gas as a waste product of the energy creation.

In operation, the hydrogen gas produced by the reaction with the catalyzing agent 140 is provided, along with an oxygen (O₂) gas, to a fuel mixer 170 in preparation for being introduced into the combustion chamber of the internal combustion engine 130. The oxygen can be provided by a source of compressed oxygen, or otherwise, by an air separator 180, as shown. In the instant embodiment, the air separator 180 has an inlet for receiving air, preferably from an air compressor (not shown in FIG. 1), which receives the air from an air dryer (not shown in FIG. 1). The compressor forces air from the air dryer into the air separator 180, which may be a pressure swing adsorber, wherein oxygen is separated from the air. This method of air separation, also known as pressure swing adsorption (PSA), is achieved with significantly less energy in comparison to the liquefying of oxygen (i.e., another known technique of air separation).

Using PSA, a bed of crystal zeolite is utilized to trap the nitrogen portion of the air, yet allow the oxygen to pass through. Thus, the air separator 180 produces a stream of oxygen (O₂) and a stream of nitrogen (N₂). The oxygen stream is provided to a fuel mixing device or mixer 170. The nitrogen is routed out from the air separator 180, to a valve 182, from which it can be provided by an outlet to a tank (not shown) for storage and/or use.

The resultant oxygen produced through PSA can have from a 90% to 95% purity. Note that, although the embodiment of FIG. 1 is described as using an air separator 180 that utilizes PSA to separate oxygen and nitrogen from the air, the invention is not meant to be limited thereto, as other air separation methods may be used without departing from the scope of the instant invention. The oxygen exiting the air separator 180 can, optionally, be directed into a vessel that is maintained under pressure, prior to being providing it to the fuel mixer 170.

The fuel mixer 170 mixes the received oxygen with a fuel component H₂ and provides the fuel mixture to the combustion chamber of the engine 130, where it is ignited. In one particular preferred embodiment of the invention, control valves 172, 174 are used to maintain a stoichiometric air fuel ratio of approximately 2:1 in the combustion chamber of the engine 130. More particularly, 2H₂+O₂=H₂O+energy. The combustion of the fuel mixture occurring in the internal combustion engine 130 produces water vapor and heat as a waste byproduct at the output 130a of the engine 130. This heat waste byproduct, which is wasted and purposely dissipated in a conventional internal combustion engine, is used in this process, thus rendering the operation of the engine of the invention substantially more efficient as compared to the 30% efficiency of a conventionally operated internal combustion engine. Stated differently, by way of explanation, the heat being rejected is, for all practical purposes, impossible to recover. However, it should be understood that by practicing the method of the present invention, significant amounts of latent heat as super-heated vapor can be recovered and converted to useful fuel product, thereby increasing the efficiency of the internal combustion engine, as well as, the furnace boiler system.

As shown in FIG. 1, at least a portion of the steam (water vapor) produced at the exhaust of the internal combustion engine 130 is provided to the catalyzing agent 140. The catalyzing agent 140 receives steam as a waste product from the combustion process in the internal combustion engine, via the manifold 134 and water vapor or steam from the valve 117.

If desired, a portion of the steam produced at the outlet of 130 can also be diverted to a steam turbine (not shown) which, in turn, generates electricity that can be used and/or stored, as desired. The steam from the turbine can additionally be brought back to the catalyzing agent 140 and converted to hydrogen.

Note that the H₂ component must, at least initially, be provided from a storage tank or other source of hydrogen fuel gas, in order to start the engine 130. However, once started, the system 100 will use water from the tank 110 and from the exhaust of the engine 130 to produce hydrogen to be fed back to the fuel mixer 170, via the tank 160, for use as the fuel component to the mixer 170. Additional hydrogen fuel gas produced from the operation of the system 100 of the invention can be routed outside of the system by a valve (not shown), for later use.

In the system 100, although water vapor/steam is produced as a byproduct of the combustion of the fuel gas product, this water vapor/steam may not be enough to fuel the vehicle for sustained operation. As such, water used to cool the engine 130 is also consumed during operation of the vehicle, which water is replaced by water from the tank 110. Thus, during operation, the amount of water held in the tank 110 will be depleted. As with a conventional vehicle, a gauge 190 can be provided in the vehicle to inform the operator of the water level in the tank 110, and alert the operator to when the water in the tank should be replenished.

In this way, a fuel component H₂ produced by the system 100 from water vapor in the system 100 is made into a component of a fuel mixture that is combusted in the internal combustion engine 130 as part of the engine combustion process to operate the engine 130. The operation of the engine 130 can be used to drive an electrical generator 132 that, in the preferred embodiment, produces a conventional three-phase AC output. The electrical output from the generator 132 can be stored, for example, in a battery and/or battery pack 137, and/or can be used to provide electrical power to electrical processes in the system 100. In one particular example, the generator 132 can be used to provide power to an alternative catalyst heater apparatus. Additionally, when the internal combustion engine 130 is incorporated into a motor vehicle, it should also be understood that the combustion process is, naturally, used to drive the motor vehicle, in the same manner as traditional internal combustion engines in known motor vehicles, including hybrid and pure electric vehicles.

As can be seen from the foregoing, the system 100 of FIG. 1 provides an internal combustion engine that does not utilize fossil fuels for combustion, nor does it produce a harmful waste product. Additionally, the hydrogen gas produced in the present system is produced at a much lower cost than in other systems, thus, moving us closer to a “hydrogen economy”.

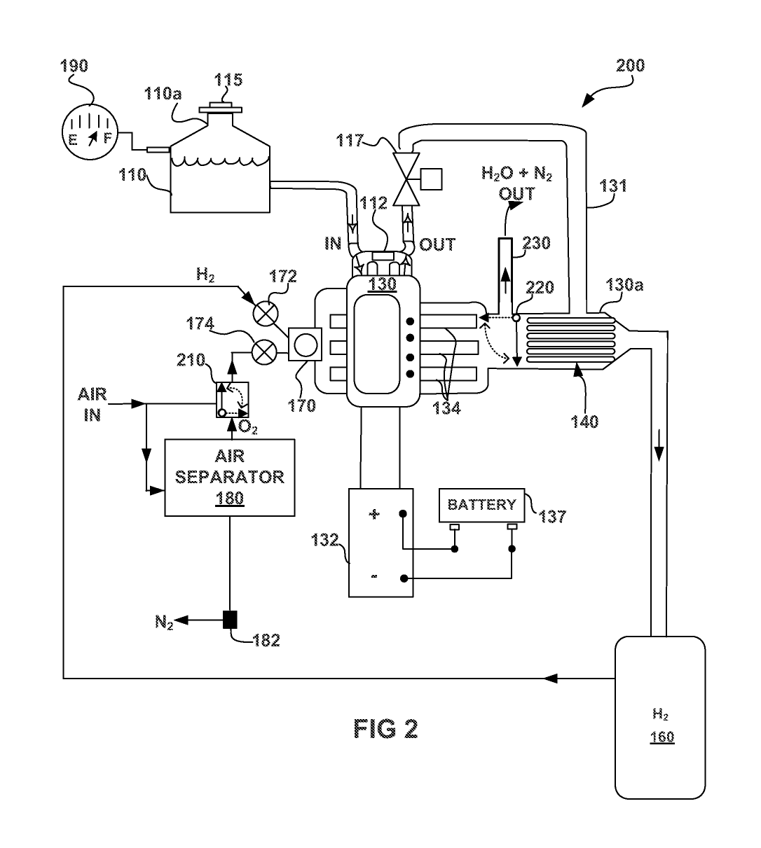

Referring now to FIG. 2, there is shown a basic diagram for a system 200 for generating hydrogen fuel gas, in accordance with another embodiment of the invention. More particularly, the system 200 of FIG. 2 is substantially similar to the system 100 of FIG. 1, with like reference numbers identifying like functioning parts. However, the system 200 of FIG. 2 differs from the system 100 of FIG. 1 in that it includes additional components that permit the engine 130 to operate in an inline “bypass mode” of operation. More particularly, instead of using the substantially pure O₂ from the air separator 180 as an input to the fuel mixture, the system 200 “bypasses” this input in order to provide ambient air as the oxygen source for the fuel mixture. This ambient air, provided from an air inlet AIR IN, is still provided to the combustion chamber 170 by the control valve 172 in a predetermined ratio with H₂ gas from tank 160. A similar “bypass” is provided at the exhaust side of the internal combustion engine 130, to ensure that the nitrogen containing waste exhausted from the exhaust pipes 134 is vented to air, rather than being provided to the hydrogen tank 160.

More particularly, as shown in FIG. 2, a flow diverter 210 is provided that selectively, based on its state, provides one of air or separated O₂ to enter the combustion chamber 170, via the control valve 174. On the exhaust side, a second flow diverter 220 is provided at the input to the catalytic converter section 130a to selectively divert to the atmosphere (i.e., in a first position) the H₂O and N₂ exhaust resulting from the combustion of the fuel mixture including the unseparated (i.e., ambient) air, prior to its reaching the catalytic converter section 130a. In a second position, the flow diverter 220 is set to divert H₂ gas to the tank 160 when pure O₂ from the air separator 180 is used as the oxygen source of the fuel mixture, as previously described in connection with the system 100 of FIG. 1.

It should be understood that the state of the flow diverter 210 is tied to the state of the flow diverter 220, to ensure that when ambient air is used to provide the oxygen component to the fuel mixture, the nitrogen containing waste product is exhausted out to the ambient air via the exhaust pipe 230. Similarly, when the flow diverter 210 provides separated O₂ to the fuel mixer, the states of the flow diverters 210, 220 are coordinated to provide the H₂ gas created in the catalytic converter section 130a to the storage tank 160. Thus, in the bypass mode of operation, the system 200 can operate the internal combustion engine 130 (and generate electricity via the alternator 132) on a fuel mixture generated from previously stored hydrogen from tank 160 and ambient air provided from an inlet port AIR IN.

In one particular embodiment of the system 200 of FIG. 2, at times when air is provided directly from the air inlet port to the control valve 174, the pump 112 and/or the control valve 117 can be turned off, thus preventing steam from entering the catalytic converter section 130a, via the pipe 131. However, if desired, even with the flow diverter 220 set to vent the exhaust from the exhaust pipes 140 to atmosphere, via the pipe 230, steam from the control valve 117 can still be provided to the catalytic converter section 130a, if desired. In such a configuration, the exhaust from the internal combustion engine 130 is vented to the atmosphere, while water originating from the tank 110 is used to generate steam that is converted to H₂ gas in the catalytic converter section 130a that is stored in the tank 160. H₂ gas, so created, can be cycled back into the combustion chamber 170, via the control valve 172, to form a fuel mixture with ambient air from the air inlet port AIR IN. In such a configuration, the system 200 can be used to generate H₂ gas used in its own operation, without the need for an air separator 180 for providing substantially pure O₂. Note that, the catalyst 140 should be arranged in the catalytic converter section 130a such that a portion of the catalyst 140 is always in the exhaust air stream. Thus, the catalyst 140 is always heated by the exhaust from the manifold 134, regardless of the position of the flow divertor 220.

Thus, it can be seen from the foregoing that the system 200 of FIG. 2 can be selectively operated to provide the internal combustion engine 130 with a fuel mixture containing H₂ and either O₂ from an air separator 180 or ambient air from an air inlet port. This bypass mode can be useful at times when the zeolite in the air separator 180 needs to be replaced and/or replenished.

In one particular alternate embodiment of the invention, the air separator 180 and diverter 210 are omitted entirely, and a flow diverter 220 is permanently set to vent the exhaust gases from the exhaust pipes 134 to air, while simultaneously diverting steam from the control valve 117 to the catalytic converter section 130a. Such an alternate system uses only ambient air as the oxygen source in the fuel mixture, while still producing H₂ for storage in the tank 160 and subsequent use in the fuel mixture. Other modifications can be made to the presently described invention while still keeping within the spirit of the present invention. For example, if desired, the flow diverter 220 can be moved after the catalytic converter section 130a.

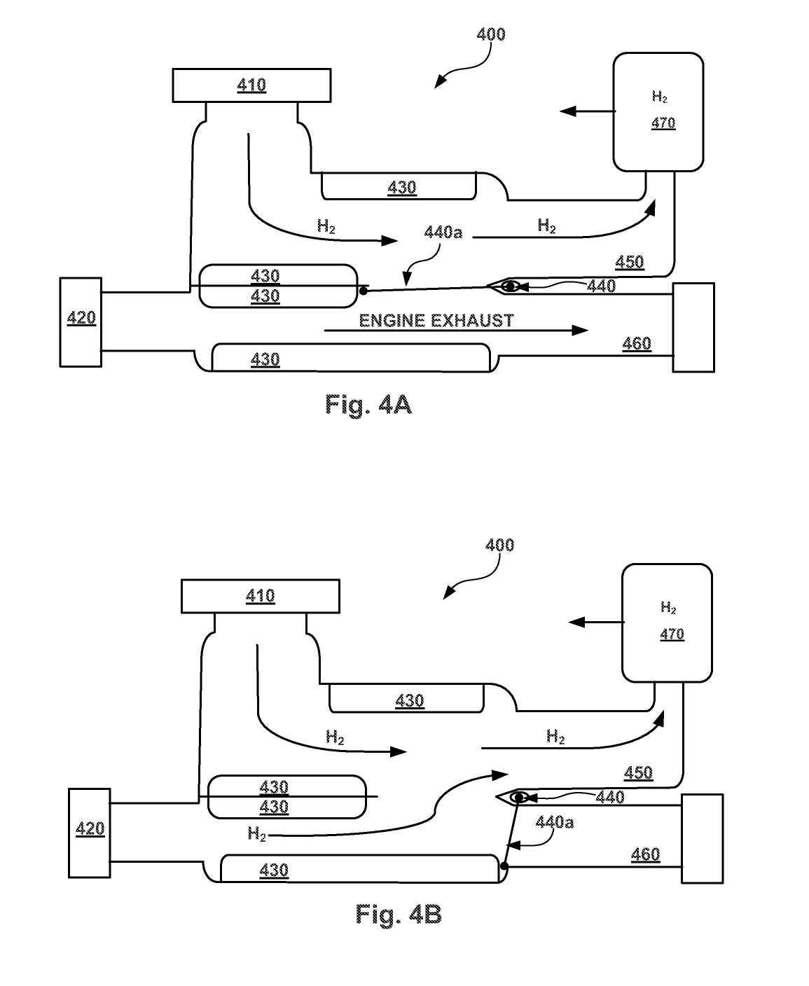

It is envisioned that other embodiments of a catalytic converter section having a bypass mode wherein nitrogen containing engine exhaust can be vented to atmosphere can be provided without deviating from the spirit of the instant invention. For example, in one particular embodiment of the invention, a catalytic converter section 400 of FIGS. 4A and 4B can be substituted for the flow diverter 220, exhaust 230 and catalytic converter section 130a of the embodiment of FIG. 2. Referring now to FIGS. 2, 4A and 4B, the catalytic converter section 400 includes a first inlet port 410 for receiving water vapor or steam from the control valve 117 of FIG. 2 and a second inlet port 420 for receiving exhaust from the exhaust manifold 134 of FIG. 2. Each of inputs from the ports 410, 420 are exposed to the catalysts 430, which are heated by waste heat from the combustion process. Each of the catalysts 430 can be one of the catalyzing agents described hereinabove in connection with FIGS. 1 and 2.

As with the embodiment described in connection with FIG. 2, the routing of the input streams from the input ports 410, 420 depends on whether ambient air or purified O₂ is used as the oxidant in the fuel mixture. For example, if the flow diverter 210 of FIG. 2 is set to provide ambient air as the oxidant in the fuel mixture, as described above, than a flow diverter or bypass switch 440 in the catalytic converter section 400 can be closed to create two separate output channels through the catalytic converter section 400. More particularly, as shown in FIG. 4A, the blade 440a of the flow diverter 440 prevents the nitrogen containing engine exhaust from flowing into the channel 450, and from there, to the hydrogen tank 470. Rather, the nitrogen containing engine exhaust passes through the channel 460 of the catalytic converter section 400 and out an outlet port to be released into the atmosphere. Simultaneously, steam provided from the control valve 117 of FIG. 2 is provided to the inlet port 410 and is converted to hydrogen gas through exposure to the heated catalyst 430 contained in the channel 450. Hydrogen gas so produced is routed to, and stored in, the hydrogen tank 470 for later use. The blade 440a of the flow diverter 440 prevents the impure nitrogen containing exhaust from the engine from mixing with the hydrogen gas produced in the channel 450, thus ensuring that only pure hydrogen gas is stored in the tank 470. However, as described in connection with the embodiment of FIG. 2, at least a portion of the catalyst 430 should be exposed to the exhaust air stream at all times, such that the catalyst 430 is still heated by the latent heat of the exhaust, regardless of the position of the blade 440a of the flow divertor 440.

However, when oxygen gas (O₂) from the air separator 180 of FIG. 2 forms the oxidant portion of the fuel mixture by the flow diverter 210 of FIG. 2, then the blade 440a of the flow diverter 440 is set to close off the outlet port of the channel 460 of the catalytic converter section 400 and divert additional hydrogen gas into the channel 450 and tank 470. More particularly, as shown in FIG. 4B, water vapor output by the exhaust manifold 134 of FIG. 2 is provided to the inlet port 420 of the catalytic converter section 400, where it is exposed to the catalysts 430. As with the previously described embodiments, the catalysts 430 are heated by the waste heat produced by the combustion of the fuel mixture in the internal combustion engine 130 of FIG. 2. Exposure of the steam from the inlet port 420 to the heated catalyst 430 produces a stream of hydrogen gas that is diverted by the blade 440a of the flow diverter 440 into the channel 450. This hydrogen gas stream combines with a stream of hydrogen gas produced in the channel 450, as described above in connection with FIG. 4A, and the combined hydrogen gas stream is provided to the tank 470.

Thus, it can be seen that the catalytic converter section 400 can be used in place of the catalytic converter section 130a of FIG. 2 to provide an alternate bypass mode of operation.

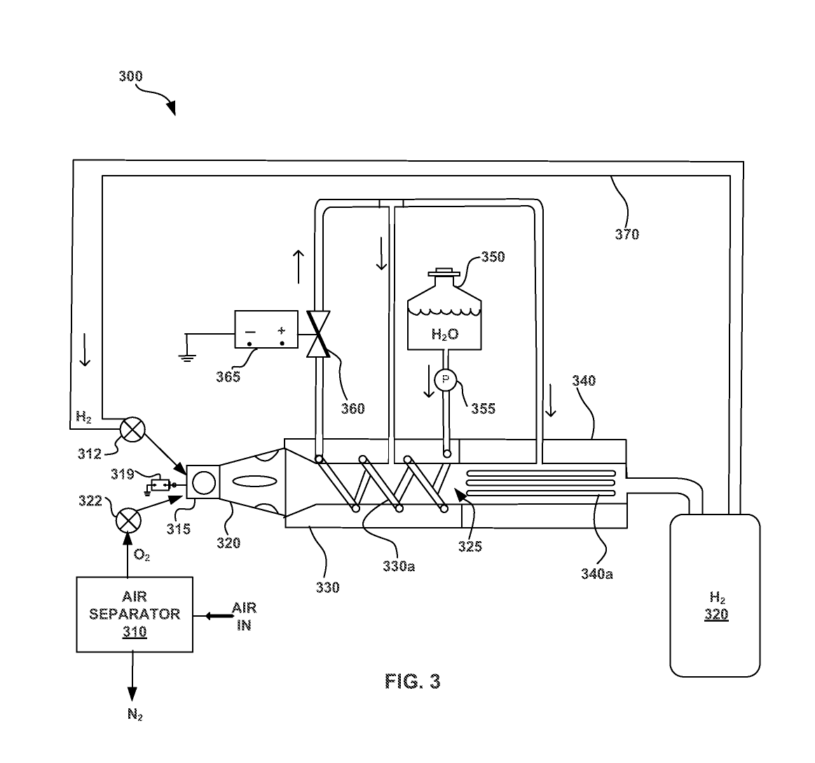

Referring, more particularly, to FIG. 3, there is shown a basic diagram for a system 300 for generating hydrogen fuel gas, in accordance with a further embodiment of the invention. As with the previously described embodiments, the system 300 includes an air separator 310 that receives air in, and produces an output stream of O₂ and a second output stream of N₂. As with each embodiment, the air separator 310 can include a known means of air separation. In one preferred embodiment, the air separator 310 includes a compressor that forces air received from an air dryer into a pressure swing adsorber, wherein oxygen is separated from the air in the process known as pressure swing adsorption (PSA). Note that, as with the embodiment of FIG. 1, other types of air separators and/or sources of O₂ may be used without deviating from the spirit of the instant invention.

The separated oxygen (O₂) stream, having from a 90% to a 95% purity, can be stored in a vessel, which is maintained under pressure. The separated oxygen is then provided to a fuel combustion chamber 315, along with hydrogen fuel gas (H₂) provided from a storage tank 320, via the control valves 312 and 322. The oxygen mixes with the hydrogen in the combustion chamber 315 to form a fuel gas mixture that is ignited using the ignition element 319.

A nozzle 320 directs resultant exhaust gases produced in the combustion chamber 315 into and through an exhaust duct 325. As shown more particularly in FIG. 3, the exhaust duct 325 passes through two distinct sections of the system 300, i.e., a boiler section 330 and a catalytic converter section 340. The boiler section 330 is characterized by boiler coils 330a in thermal communication with the exhaust in exhaust duct 325, while the catalytic converter section 340 includes a catalyzing agent or catalyst 340a, contained therein. As described elsewhere herein, the catalyst 340a may be iron, zinc, magnesium or any other material that oxidizes under heat to produce hydrogen gas.

Referring back to FIG. 3, the system 300 of the present embodiment is particularly suited for use in the generation of electricity using a steam turbine. In particular, water (H₂O) from a tank 350 is pumped by a pump 355 into the boiler coils 330a of the boiler section 330. As noted above, the heat of combustion of the hydrogen/oxygen fuel mixture is very high, on the order of 1000° F. Thus, the heat of combustion in the combustion chamber 315 and of the waste product (which is steam) passing through the exhaust duct 325 superheat the water circulating in the boiler coils 330a, turning that water to steam. The steam exiting the boiler section 330 can be used to drive a steam turbine 360 at a power plant, in order to generate electricity via the generator 365. Thus, the excess waste heat produced by operation of the present invention, can be used to create significant amounts of electricity from the waste steam by-product of the inventive system and method.

Additionally, the waste water or steam from the turbine can be returned to the exhaust duct 325 in the boiler section 330 and carried into the catalytic converter section 340, where it is further heated by the waste heat of the combustion reaction of the fuel mixture. The steam produced from water/steam exiting the turbine 360 is combined with the steam waste product of the reaction and is passed over the catalyst 340a of the catalytic converter section 340 of the exhaust duct 325. The catalyst 340a, which is also superheated by the waste heat of the combustion reaction, reacts with the steam to produce hydrogen gas. Hydrogen gas produced in the catalytic converter section 340 can be stored in the tank 320, wherein some percentage of the hydrogen thus produced is fed back into the system via the line 370, to fuel the combustor, while the majority can be tapped off for use as fuel.

Thus, the system of FIG. 3 provides a system that produces a usable hydrogen fuel gas from water, as well as produces significant amounts of electricity from a generator 365, without releasing harmful waste products or hydrocarbons into the atmosphere.

The present disclosure is provided to allow practice of the invention, after the expiration of any patent granted hereon, by those skilled in the art without undue experimentation, and includes the best mode presently contemplated and the presently preferred embodiment. Nothing in this disclosure is to be taken to limit the scope of the invention, which is susceptible to numerous alterations, equivalents and substitutions without departing from the scope and spirit of the invention.

1. A method of producing a hydrogen fuel product, comprising:
providing a combustion chamber;
providing H₂ and an oxidant to the combustion chamber to form a fuel gas mixture in the combustion chamber, the fuel gas mixture being ignited in the combustion chamber to produce energy and a heat of combustion byproduct;
providing water;
exposing a portion of the water to the heat of combustion byproduct to create steam;
exposing at least a portion of the steam to a catalyst heated by the heat of combustion byproduct, the catalyst being chosen such that the catalyst, when heated, reacts with the steam to produce H₂.

2. The method of claim 1, wherein at least a portion of the H₂ produced is provided to the combustion chamber to form the fuel gas mixture.

3. The method of claim 1, wherein the catalyst includes at least one of iron, zinc and magnesium.

4. The method of claim 1, wherein the combustion chamber is part of an internal combustion engine.

5. The method of claim 4, wherein the internal combustion engine is located in a vehicle.

6. The method of claim 4, wherein at least a portion of the internal combustion engine is made from a ceramic material.

7. The method of claim 1, wherein at least a portion of the steam created by exposing water to the heat of combustion byproduct is used to drive a steam turbine.

8. The method of claim 1, wherein the steam exposed to the heated catalyst includes steam produced as a byproduct of the igniting step.

9. A device for producing a hydrogen fuel gas, comprising:
a source of H₂ gas;
a source of an oxidant;
a combustion chamber connected to the source of hydrogen gas and the source of an oxidant for receiving the hydrogen gas from the hydrogen gas source and an oxidant from the oxidant source in a certain proportion to form a fuel mixture, the combustion chamber including an ignition element for igniting the fuel mixture in the combustion chamber;
a water source arranged to provide water to a region with a heat of combustion byproduct of the ignition of the fuel mixture in the combustion chamber to create steam.
a catalytic converter section heated by said heat of combustion byproduct, the catalytic converter section including a catalyst being chosen such that, the catalyst, when heated, reacts with a portion of the steam to produce H₂.

10. The device of claim 9, wherein an output of the catalytic converter is configured to provide at least a portion of the H₂ produced to the combustion chamber to said source of H₂ gas.

11. The device of claim 9, wherein the combustion chamber is part of an internal combustion engine.

12. The device of claim 11, wherein at least a portion of the internal combustion engine is made from a ceramic material.

13. The device of claim 9, wherein at least a portion of said steam includes steam received from said combustion chamber.

14. The device of claim 9, wherein the catalyst includes at least one of iron, zinc and magnesium.

15. The device of claim 11, wherein the internal combustion engine is located in a vehicle.

16. The device of claim 9, wherein at least a portion of the steam created is used to drive a steam turbine.

17. The device of claim 16, wherein steam exiting said steam turbine is provided to said exhaust duct, via the inlet ports, for reaction with said catalyst

18. A system for generating hydrogen gas, comprising:
an internal combustion engine including a combustion chamber, said combustion chamber configured to receive H₂ gas from a source of H₂ gas and an oxidant from a source of an oxidant to produce a fuel mixture that, when ignited, produces energy and heat;
a catalytic converter section containing a catalyst chosen such that the catalyst, when heated, reacts with steam to produce H₂, said catalyst being arranged to be heated by heat produced from the ignition of said fuel mixture;
said catalytic converter section arranged to receive steam from at least one of an output of said combustion chamber and a heat recovery output of the internal combustion engine;
said catalytic converter having an output, wherein hydrogen gas produced from the reaction of said steam with said catalyst is output from said catalytic converter, with at least a portion of said hydrogen gas provided at the output of said catalytic converter being provided to said combustion chamber for ignition.

19. The device of claim 18, wherein the internal combustion engine is located in a vehicle.

20. A system for generating hydrogen gas, comprising:
a combustion chamber including an input and an output;
the input of the combustion chamber receiving a fuel mixture of hydrogen gas and an oxidant in a predetermined ratio;
the output of the combustion chamber being in fluid communication with an exhaust duct;
said exhaust duct including a catalytic converter section including a catalyst chosen such that the catalyst, when heated by exhaust, reacts with steam to produce H₂;
said catalytic converter section including a source of steam produced from water exposed to heat produced by the ignition of the fuel gas mixture in the combustion chamber;
said catalytic converter section having an output, wherein hydrogen gas produced from the reaction of said steam with the heated catalyst is output from said catalytic converter section; and
at least a portion of said hydrogen gas provided at the output of said catalytic converter section being provided as part of said fuel mixture to said combustion chamber for ignition.

21. The system of claim 20, wherein the catalyst includes at least one of iron, zinc and magnesium.

22. The system of claim 20, wherein the source of steam includes steam entering said catalytic converter section from an inlet port in said exhaust duct after passing through a steam turbine.

23. The device of claim 20, wherein water is used as part of a cooling process and the steam exposed to the heated catalyst includes steam produced as a byproduct of the cooling process.

24. The system of claim 20, wherein said exhaust duct further includes a boiler section that receives water from an external source, said water being converted to steam in said boiler section and said water is converted to steam in said boiler section by waste heat in said exhaust duct resulting from an ignition of the fuel gas mixture in the combustion chamber.

25. The system of claim 24, wherein at least a portion of said steam is used to drive a steam turbine.

26. The system of claim 25, wherein steam exiting said steam turbine is provided to said exhaust duct, via the inlet ports, for reaction with said catalyst.
